(19) United States
(12) Patent Application Publication
(10) Pub. No.: US 2016/0282829 A1
(43) Pub. Date: Sep. 29, 2016

(54) CONTROLLER AND CONTROL METHOD

(71) Applicant: AZBIL CORPORATION, Chiyoda-ku (JP)

(72) Inventors: Hayato MOTOHASHI, Chiyoda-ku (JP); Fumihiro SUGAWARA, Chiyoda-ku (JP); Toru TAKAGI, Chiyoda-ku (JP)

(73) Assignee: AZBIL CORPORATION, Chiyoda-ku (JP)

(21) Appl. No.: 15/079,113

(22) Filed: Mar. 24, 2016

(30) Foreign Application Priority Data
Mar. 26, 2015 (JP) 2015-063797

(51) Int. Cl. G05B 19/042

(52) U.S. Cl. CPC G05B 19/042; G05B 2219/2614

(57) ABSTRACT

A controller includes a control computation unit, a control computation output correction unit, and a final-control-element output upper-lower limit processing unit. The control computation unit calculates, for each control cycle, a control computation output value by performing a control computation using a controlled variable and a set point as input values. The control computation output correction unit corrects the control computation output value to a predetermined final-control-element output upper limit in a case where the control computation output value is equal to or larger than a predetermined threshold A. The final-control-element output upper-lower limit processing unit outputs to a control target a value obtained by limiting the corrected control computation output value to a value that is equal to or larger than a predetermined final-control-element output lower limit and that is equal to or smaller than the final-control-element output upper limit, as a final-control-element output value.

### CROSS-REFERENCE TO RELATED APPLICATIONS

This application claims priority to Japanese Application No. 2015-063797, filed Mar. 26, 2015, the entire contents of which are incorporated herein by reference.

### BACKGROUND OF THE INVENTION

1. Field of the Invention

The present invention relates to a controller and a control method used in various fields, such as temperature control.

2. Description of the Related Art

As a technique for improving control stability during a settling period and control responsivity during a transition period, gain scheduling is available (see Japanese Unexamined Patent Application Publication No. 8-161004). In a case where gain scheduling is applied to proportional-integral-differential (PID) control, switching of three parameters, namely, a proportional compensation parameter, an integral compensation parameter, and a differential compensation parameter (hereinafter referred to as PID parameters) is performed, and therefore, two or more sets of PID parameters need to be adjusted. That is, in a case of two sets of parameters, six parameters need to be adjusted. It is often the case that, among the PID parameters, scheduling is performed only on the proportional compensation parameter. In this case, one set of PID parameters and a proportional compensation parameter on which scheduling is performed, namely, four parameters in total, need to be adjusted.

PID parameters are adjusted as follows, for example, in a case where gain scheduling is applied to PID control.

(I) PID parameters used during a settling period are determined by using an existing method, such as auto-tuning. Here, the PID parameters are finely adjusted by using a trial-and-error method as needed.

(II) The PID parameters determined in (I) are used as references to determine PID parameters, with which responsivity during a transition period is increased, by using a trial-and-error method.

(III) Switching between the result obtained in (I) and that obtained in (II) is performed, or a fine adjustment is made on the basis of a response from gain scheduling control for interpolation by using a trial-and-error method.

As described above, with the related art, a plurality of trial-and-error experiments are required in order to produce a control response desired by a user, which takes longer.

In gain scheduling control or the like, switching of the control parameters and interpolation are performed, and therefore, the adjustment takes longer. Because of such a concern, it is often the case that an attempt of achieving both control stability during a settling period and control responsivity during a transition period is abandoned. In a case of employing an adjustment result obtained while control responsivity is compromised, the tact time of a control target apparatus falls behind, resulting in decreased productivity. In a case of employing an adjustment result obtained while control stability is compromised, the quality of products produced by a control target apparatus is reduced.

### SUMMARY OF THE INVENTION

The present invention has been made in order to address the above-described issues, and there are provided a controller and a control method with which the time taken to make an adjustment in order to achieve both control stability during a settling period and control responsivity during a transition period can be reduced.

A controller according to one aspect of the present invention includes a control computation unit, a control computation output correction unit, and a final-control-element output upper-lower limit processing unit. The control computation unit calculates, for each control cycle, a control computation output value by performing a control computation using a controlled variable and a set point as input values. The control computation output correction unit corrects the control computation output value calculated by the control computation unit to a predetermined final-control-element output upper limit in a case where the control computation output value is equal to or larger than a predetermined threshold A. The final-control-element output upper-lower limit processing unit outputs to a control target a value obtained by limiting the control computation output value corrected by the control computation output correction unit to a value that is equal to or larger than a predetermined final-control-element output lower limit and that is equal to or smaller than the final-control-element output upper limit, as a final-control-element output value.

A controller according to one aspect of the present invention includes a control computation unit, a control computation output correction unit, and a final-control-element output upper-lower limit processing unit. The control computation unit calculates, for each control cycle, a control computation output value by performing a control computation using a controlled variable and a set point as input values. The control computation output correction unit corrects the control computation output value calculated by the control computation unit to a predetermined final-control-element output lower limit in a case where the control computation output value is equal to or smaller than a predetermined threshold B. The final-control-element output upper-lower limit processing unit outputs to a control target a value obtained by limiting the control computation output value corrected by the control computation output correction unit to a value that is equal to or larger than the final-control-element output lower limit and that is equal to or smaller than a predetermined final-control-element output upper limit, as a final-control-element output value.

In one exemplary configuration of the above-described controller, the threshold A may be larger than a lager one of the control computation output value that is calculated by the control computation unit during a control settling period after a set point change and the control computation output value that is calculated by the control computation unit during a control settling period after application of a disturbance, and may be smaller than the final-control-element output upper limit.

In one exemplary configuration of the above-described controller, the above-described controller may further include a timing detection unit that, in response to an event that corresponds to a set point change or to application of a disturbance, detects a timing at which the threshold A is to be switched to the threshold A that is used in a case of a set point change or a timing at which the threshold A is to be switched to the threshold A that is used in a case of application of a disturbance. The threshold A may be set to a value that is used in a case of a set point change and to a value that is used in a case of application of a disturbance. The control computation output correction unit may switch, in a case where the timing detection unit determines the detected timing to be the timing at which the threshold A is to be switched to the threshold A that is used in a case of a set point change, the threshold A to be used to the threshold A that is used in a case of a set point change, and may switch, in a case where the timing detection unit determines the detected timing to be the timing at which the threshold A is to be switched to the threshold A that is used in a case of application of a disturbance, the threshold A to be used to the threshold A that is used in a case of application of a disturbance. The threshold A that is used in a case of a set point change may be larger than the control computation output value calculated by the control computation unit during a control settling period after a set point change and may be smaller than the final-control-element output upper limit. The threshold A that is used in a case of application of a disturbance may be larger than the control computation output value calculated by the control computation unit during a control settling period after application of a disturbance and may be smaller than the final-control-element output upper limit.

In one exemplary configuration of the above-described controller, the threshold B may be larger than the final-control-element output lower limit, and may be smaller than a smaller one of the control computation output value that is calculated by the control computation unit during a control settling period after a set point change and the control computation output value that is calculated by the control computation unit during a control settling period after application of a disturbance.

In one exemplary configuration of the above-described controller, the above-described controller may further include a timing detection unit that, in response to an event that corresponds to a set point change or to application of a disturbance, detects a timing at which the threshold B is to be switched to the threshold B that is used in a case of a set point change or a timing at which the threshold B is to be switched to the threshold B that is used in a case of application of a disturbance. The threshold B may be set to a value that is used in a case of a set point change and to a value that is used in a case of application of a disturbance. The control computation output correction unit may switch, in a case where the timing detection unit determines the detected timing to be the timing at which the threshold B is to be switched to the threshold B that is used in a case of a set point change, the threshold B to be used to the threshold B that is used in a case of a set point change, and may switch, in a case where the timing detection unit determines the detected timing to be the timing at which the threshold B is to be switched to the threshold B that is used in a case of application of a disturbance, the threshold B to be used to the threshold B that is used in a case of application of a disturbance. The threshold B that is used in a case of a set point change may be larger than the final-control-element output lower limit and may be smaller than the control computation output value calculated by the control computation unit during a control settling period after a set point change. The threshold B that is used in a case of application of a disturbance may be larger than the final-control-element output lower limit and may be smaller than the control computation output value calculated by the control computation unit during a control settling period after application of a disturbance.

A control method according to one aspect of the present invention includes a control computation step of calculating, for each control cycle, a control computation output value by performing a control computation using a controlled variable and a set point as input values; a control computation output correction step of correcting the control computation output value calculated in the control computation step to a predetermined final-control-element output upper limit in a case where the control computation output value is equal to or larger than a predetermined threshold A; and a final-control-element output upper-lower limit processing step of outputting to a control target a value obtained by limiting the control computation output value corrected in the control computation output correction step to a value that is equal to or larger than a predetermined final-control-element output lower limit and that is equal to or smaller than the final-control-element output upper limit, as a final-control-element output value.

A control method according to one aspect of the present invention includes a control computation step of calculating, for each control cycle, a control computation output value by performing a control computation using a controlled variable and a set point as input values; a control computation output correction step of correcting the control computation output value calculated in the control computation step to a predetermined final-control-element output lower limit in a case where the control computation output value is equal to or smaller than a predetermined threshold B; and a final-control-element output upper-lower limit processing step of outputting to a control target a value obtained by limiting the control computation output value corrected in the control computation output correction step to a value that is equal to or larger than the final-control-element output lower limit and that is equal to or smaller than a predetermined final-control-element output upper limit, as a final-control-element output value.

According to the aspects of the present invention, the control computation output correction unit is provided which corrects the control computation output value calculated by the control computation unit to the predetermined final-control-element output upper limit in a case where the control computation output value is equal to or larger than the predetermined threshold A. Therefore, trial-and-error experiments are required only for adjusting the threshold A. As a consequence, it is possible to reduce the time taken to make an adjustment in order to achieve both control stability during a settling period and control responsivity during a transition period.

In the aspects of the present invention, different values are respectively used as the threshold A that is used in a case of a set point change and as the threshold A that is used in a case of application of a disturbance. As a consequence, it is possible to further improve a control response upon a set point change and a control response upon application of a disturbance.

According to the aspects of the present invention, the control computation output correction unit is provided which corrects the control computation output value calculated by the control computation unit to the predetermined final-control-element output lower limit in a case where the control computation output value is equal to or smaller than the predetermined threshold B. Therefore, trial-and-error experiments are required only for adjusting the threshold B. As a consequence, it is possible to reduce the time taken to make an adjustment in order to achieve both control stability during a settling period and control responsivity during a transition period.

In the aspects of the present invention, different values are respectively used as the threshold B that is used in a case of a set point change and as the threshold B that is used in a case of application of a disturbance. As a consequence, it is possible to further improve a control response upon a set point change and a control response upon application of a disturbance.

### BRIEF DESCRIPTION OF THE DRAWINGS

FIG. 1A is a diagram illustrating examples of changes in controlled variables according to an embodiment of the present invention and according to the related art when a set point is changed; and FIG. 1B is a diagram illustrating examples of changes in control computation output values according to an embodiment of the present invention and according to the related art when a set point is changed.

FIG. 2A is a diagram illustrating examples of changes in controlled variables according to an embodiment of the present invention and according to the related art when a disturbance is applied; and FIG. 2B is a diagram illustrating examples of changes in control computation output values according to an embodiment of the present invention and according to the related art when a disturbance is applied.

FIG. 3 is a diagram for describing a correction process performed on a control computation output value according to an embodiment of the present invention.

FIG. 4 is a block diagram illustrating a configuration of a controller according to a first embodiment of the present invention.

FIG. 5 is a flowchart illustrating an operation of the controller according to the first embodiment of the present invention.

FIG. 6 is a block diagram illustrating a configuration of a controller according to a second embodiment of the present invention.

FIGS. 7A and 7B are diagrams illustrating examples of control responses according to the first embodiment of the present invention.

FIGS. 8A and 8B are diagrams illustrating examples of control responses according to the second embodiment of the present invention.

FIG. 9 is a diagram for describing a correction process performed in a case where a control computation output value drops.

FIG. 10 is a block diagram illustrating a configuration of a controller according to a third embodiment of the present invention.

### DESCRIPTION OF THE PREFERRED EMBODIMENTS

### Principle of the Present Invention

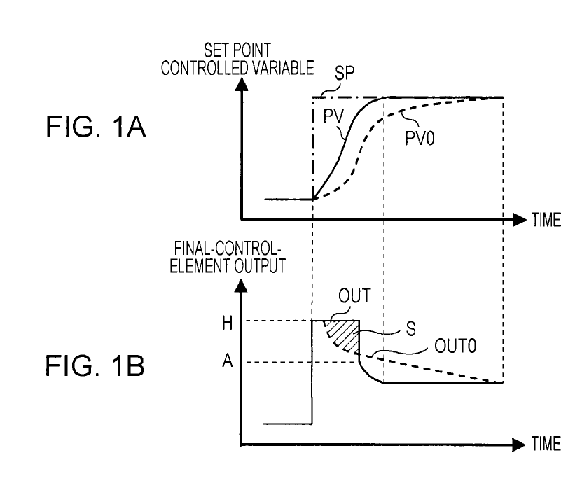

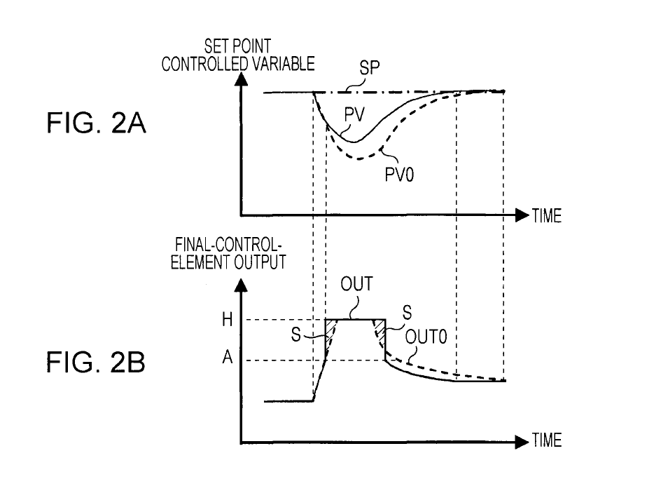

FIGS. 1A and 1B and FIGS. 2A and 2B are diagrams for describing the principle of the present invention. FIG. 1A is a diagram illustrating examples of changes in controlled variables according to an embodiment of the present invention and according to the related art when a set point is changed. FIG. 1B is a diagram illustrating examples of changes in control computation output values according to an embodiment of the present invention and according to the related art when a set point is changed. FIG. 2A is a diagram illustrating examples of changes in controlled variables according to an embodiment of the present invention and according to the related art when a disturbance is applied. FIG. 2B is a diagram illustrating examples of changes in control computation output values according to an embodiment of the present invention and according to the related art when a disturbance is applied. In FIGS. 1A and 1B and FIGS. 2A and 2B, SP represents a set point, PV0 represents a controlled variable in a case of employing a controller according to the related art which uses a single control parameter (no gain scheduling), PV represents a controlled variable in a case of employing a controller according to an embodiment of the present invention, OUT0 represents a final-control-element output value that is output from a controller according to the related art, and OUT represents a final-control-element output value that is output from the controller according to an embodiment of the present invention.

Usually, an upper limit process is performed in which, in a case where a control computation output value MV calculated in a PID control computation is larger than a predetermined final-control-element output upper limit H, the control computation output value MV is decreased to a value equal to or lower than the final-control-element output upper limit H, and the decreased value is output as the final-control-element output OUT. As seen from FIG. 1B and FIG. 2B, an upper limit process is performed so that the final-control-element output OUT0 that is output from a controller according to the related art does not exceed the final-control-element output upper limit H.

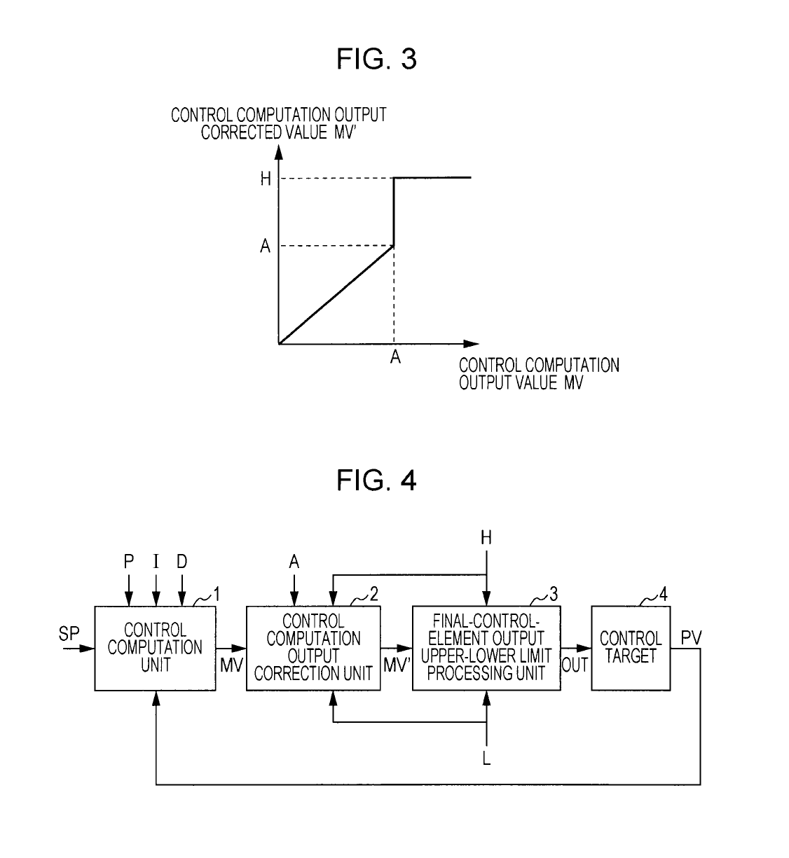

In an embodiment of the present invention, the final-control-element output upper limit H is used and, in a case where the control computation output value MV calculated in a PID control computation is equal to or larger than a threshold A specified by a user, the control computation output value MV is corrected to the final-control-element output upper limit H. That is, as illustrated in FIG. 3, in a case where the control computation output value MV calculated in a PID control computation is smaller than the threshold A, the control computation output value MV is output as the control computation output corrected value MV′ without correction (MV′=MV). In the case where the control computation output value MV is equal to or larger than the threshold A, the final-control-element output upper limit H is output as the control computation output corrected value MV′ (MV′=H).

In a situation where control responsivity is desired during a transition period in which the controlled variable PV is apart from the set point SP, the control computation output value MV is equal to or larger than the threshold A, and therefore, the final-control-element output OUT that is equal to the control computation output corrected value MV′, MV′ being equal to H (OUT=MV′=H), is output from the controller. That is, it is possible to output final-control-element output values in the portions indicated by S in FIG. 1B and FIG. 2B without changing control parameters (or PID parameters in a case of PID control). Accordingly, control responsivity during a transition period can be increased. The user may specify the value of the threshold A that satisfies the following condition,

MV₊<A<H (1).

In expression (1), MV₊ represents the control computation output value MV calculated during a control settling period after a set point change or during a control settling period after application of a disturbance. More precisely, MV₊ in expression (1) is defined as the larger one of the control computation output value MV calculated during a control settling period after a set point change and the control computation output value MV calculated during a control settling period after application of a disturbance.

On the other hand, in a situation where control stability is desired during a settling period in which the controlled variable PV is close the set point SP, the control computation output value MV is smaller than the threshold A, and therefore, the final-control-element output OUT that is equal to the control computation output corrected value MV′, MV′ being equal to MV (OUT=MV′=MV), is output from the controller. Therefore, it is possible to achieve control stability as long as one set of control parameters (or one set of PID parameters in the case of PID control), which is determined while control stability is focused, is set in the controller.

### First Embodiment

Hereinafter, embodiments of the present invention will be described with reference to the drawings. FIG. 4 is a block diagram illustrating a configuration of a controller according to a first embodiment of the present invention. The controller according to this embodiment includes a control computation unit 1, a control computation output correction unit 2, and a final-control-element output upper-lower limit processing unit 3. The control computation unit 1 calculates, for each control cycle, the control computation output value MV by performing a control computation using the controlled variable PV and the set point SP as input values. The control computation output correction unit 2 outputs the control computation output corrected value MV′ that is obtained by correcting the control computation output value MV. The final-control-element output upper-lower limit processing unit 3 performs an upper-lower limit process for limiting the control computation output corrected value MV′ to a value equal to or larger than a predetermined final-control-element output lower limit L and is equal to or smaller than the predetermined final-control-element output upper limit H.

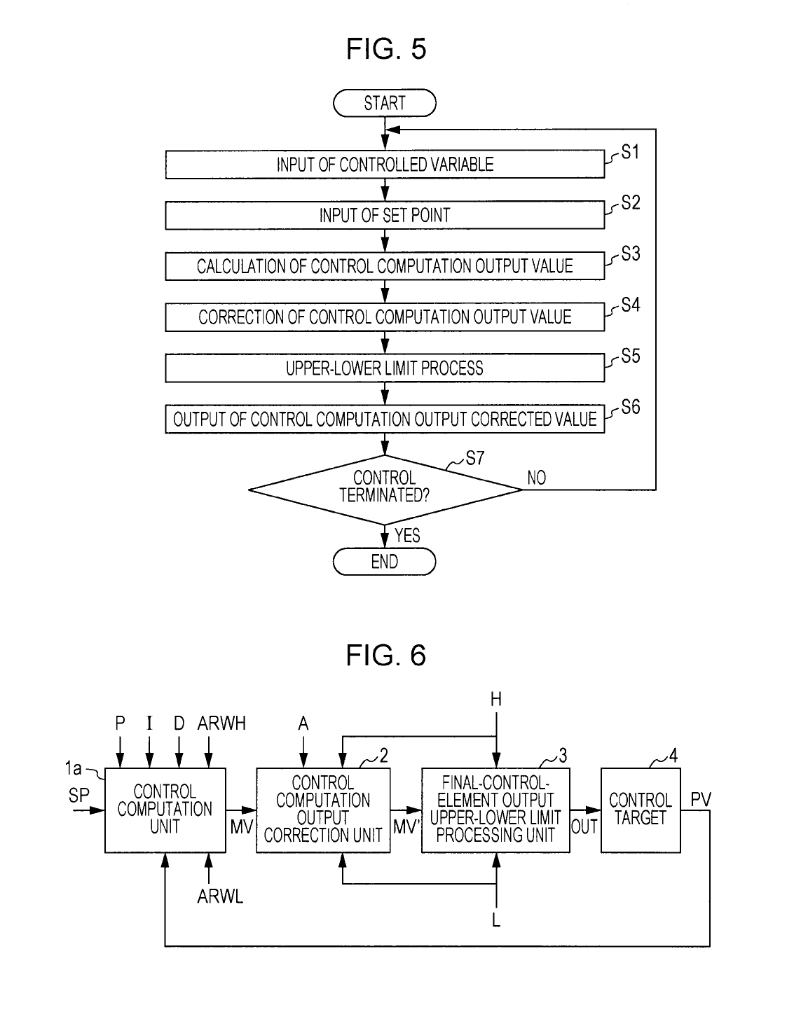

Now, an operation of the controller according to this embodiment is described with reference to FIG. 5. FIG. 5 is a flowchart illustrating an operation of the controller.

The controlled variable PV is measured by using a measuring instrument not illustrated (a temperature sensor, for example) and is input into the control computation unit 1 (step S1 in FIG. 5).

The set point SP is set by the user of the controller and is input into the control computation unit 1 (step S2 in FIG. 5).

The control computation unit 1 calculates the control computation output value MV so that the controlled variable PV matches the set point SP (step S3 in FIG. 5). As a feedback control computation algorithm, PID control is available. PID control computation is a well-known technique, and therefore, a description thereof is omitted.

The control computation output correction unit 2 outputs the control computation output corrected value MV′ that is obtained by correcting the control computation output value MV (step S4 in FIG. 5). As described above, in the case where the control computation output value MV is smaller than the threshold A, the control computation output correction unit 2 outputs the control computation output corrected value MV′ that is equal to the control computation output value MV (MV′=MV). In the case where the control computation output value MV is equal to or larger than the threshold A, the control computation output correction unit 2 outputs the control computation output corrected value MV′ that is equal to the final-control-element output upper limit H (MV′=H).

The final-control-element output upper-lower limit processing unit 3 performs an upper-lower limit process for limiting the control computation output corrected value MV′ output from the control computation output correction unit 2 to a value equal to or larger than the final-control-element output lower limit L and is equal to or smaller than the final-control-element output upper limit H (step S5 in FIG. 5) as follows:

if MV′<L, then OUT=L (2);

if MV′>H, then OUT=H (3).

That is, in a case where the control computation output corrected value MV′ output from the control computation output correction unit 2 is larger than the final-control-element output lower limit L and is smaller than the final-control-element output upper limit H, the final-control-element output upper-lower limit processing unit 3 outputs the control computation output corrected value MV′ as is as the final-control-element output OUT (OUT=MV′). In a case where the control computation output corrected value MV′ is smaller than the final-control-element output lower limit L, the final-control-element output upper-lower limit processing unit 3 sets the final-control-element output OUT to the value equal to the final-control-element output lower limit L (OUT=L). In a case where the control computation output corrected value MV′ is larger than the final-control-element output upper limit H, the final-control-element output upper-lower limit processing unit 3 sets the final-control-element output OUT to the value equal to the final-control-element output upper limit H (OUT=H).

Thereafter, the final-control-element output upper-lower limit processing unit 3 outputs the final-control-element output OUT obtained as a result of the upper-lower limit process to a control target 4 (step S6 in FIG. 5). A destination to which the final-control-element output OUT obtained as a result of the upper-lower limit process is actually output is a control device for controlling a heater, a valve, and so on.

The process in steps S1 to S6 described above is repeatedly performed for each control cycle until control is terminated in accordance with a user instruction, for example (Yes in step S7 in FIG. 5).

An example of an adjustment procedure performed by the controller according to this embodiment is as follows.

(a) Control parameters (or PID parameters in the case of PID control) used during a settling period are determined by using an existing method, such as auto-tuning. Here, the control parameters are finely adjusted by using a trial-and-error method as needed while control stability during a settling period is focused.

(b) Next, the threshold A is determined by using a trial-and-error method so as to produce desired control responses during a transition period and during a settling period.

If the threshold A is made smaller, control responsivity increases; however, the amount of overshoot of the controlled variable PV becomes larger. Therefore, when the user makes the adjustment described in (b), the user may change the threshold A so that the threshold A gradually approaches the above-described control computation output value MV₊ from the final-control-element output upper limit H by operating a threshold input unit (not illustrated) of the controller, and end the adjustment when a control response most desired by the user is produced.

In this embodiment, a plurality of sets of control parameters need not be used as in the related art disclosed by Japanese Unexamined Patent Application Publication No. 8-161004, and one set of control parameters (or PID parameters in the case of PID control) needs to be set in the control computation unit 1. As a method for adjusting the control parameters, well-known auto-tuning may be used. Accordingly, trial-and-error experiments are required only for adjusting the threshold A. The threshold A is given with the same scale as that of the control computation output value MV, and therefore, an adjusted value or an effect thereof is easily recognized. Accordingly, with this embodiment, it is possible to reduce the time taken to make an adjustment in order to achieve both control stability during a settling period and control responsivity during a transition period compared to the related art. As seen from the result illustrated in FIG. 2A, with this embodiment, it is possible to reduce a drop in the controlled variable PV due to application of a disturbance, and therefore, the influence of the disturbance can be alleviated, and control responsivity can be increased.

### Second Embodiment

Now, a second embodiment of the present invention is described. FIG. 6 is a block diagram illustrating a configuration of a controller according to the second embodiment of the present invention. The same constituent element as that in FIG. 4 is assigned the same reference numeral. The controller according to this embodiment includes a control computation unit 1a, the control computation output correction unit 2, and the final-control-element output upper-lower limit processing unit 3.

Also in this embodiment, the flow of a process performed by the controller is as described with reference to FIG. 5 in the first embodiment. This embodiment is different from the first embodiment in that the control computation unit in this embodiment is the control computation unit 1a having an anti-integral windup (anti-reset windup) function, and the user is able to specify an upper limit ARWH and a lower limit ARWL for the anti-integral windup function.

Typical controllers have an anti-integral windup function. An anti-integral windup function is a function of, in a case where the control computation output value MV calculated by the control computation unit reaches the upper limit ARWH or the lower limit ARWL, stopping the integral operation in the direction in which the control computation output value MV rises above the upper limit ARWH or in the direction in which the control computation output value MV falls below the lower limit ARWL. As a result, it is possible to suppress saturation of the control computation output value MV, accelerate a return from saturation of the control computation output value MV, and reduce a delay in control settling.

With the first embodiment, it is possible to reduce the time taken for an adjustment; however, employing the configuration of the first embodiment to a controller having an anti-integral windup function may result in decreased control responsivity.

In this embodiment, instead of setting the upper limit ARWH to the final-control-element output upper limit H (ARWH=H) and setting the lower limit ARWL to the final-control-element output lower limit L (ARWL=L) as in the related art, the user is able to specify the upper limit ARWH and the lower limit ARWL for the anti-integral windup function so that a decrease in control responsivity can be reduced. When the user adjusts the upper limit ARWH and the lower limit ARWL, the user may change the upper limit ARWH and the lower limit ARWL by operating an upper-lower limit input unit (not illustrated) of the controller, and end the adjustment when a control response most desired by the user is produced.

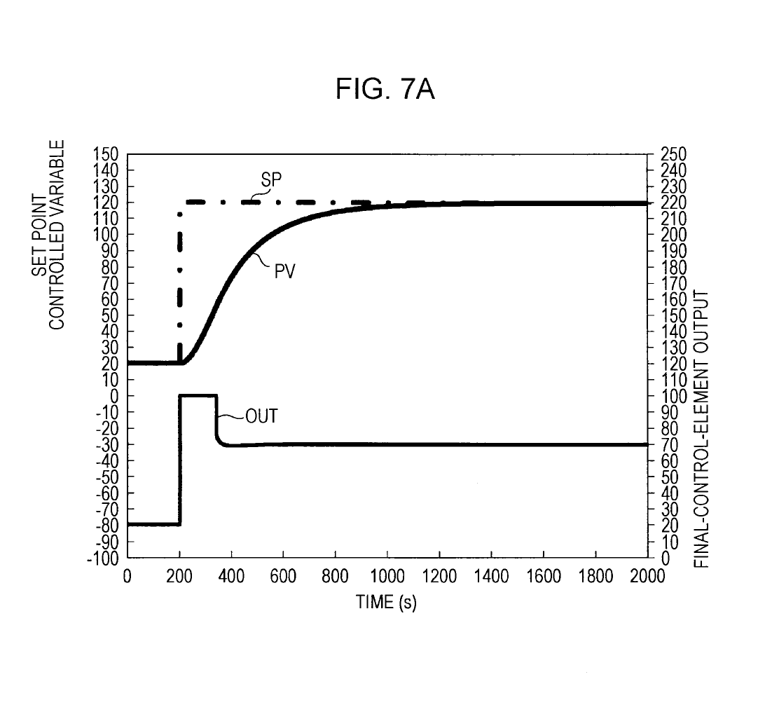

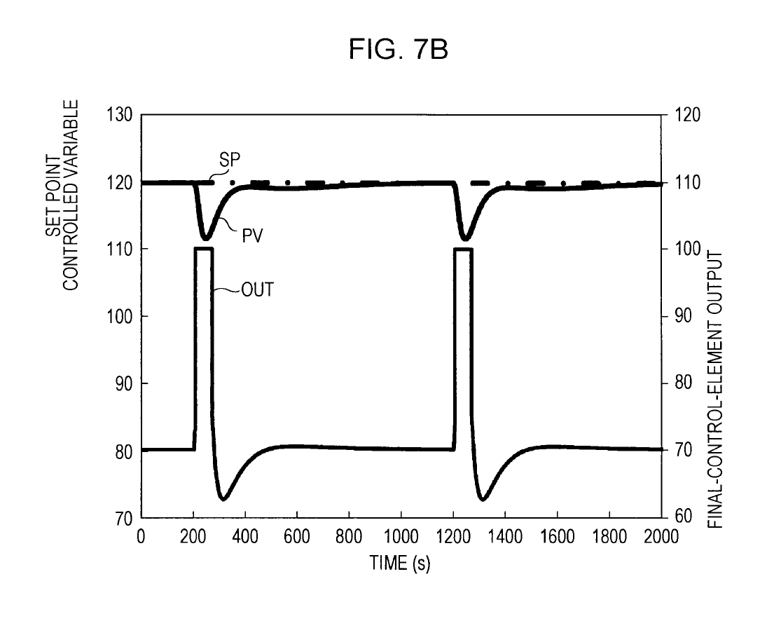

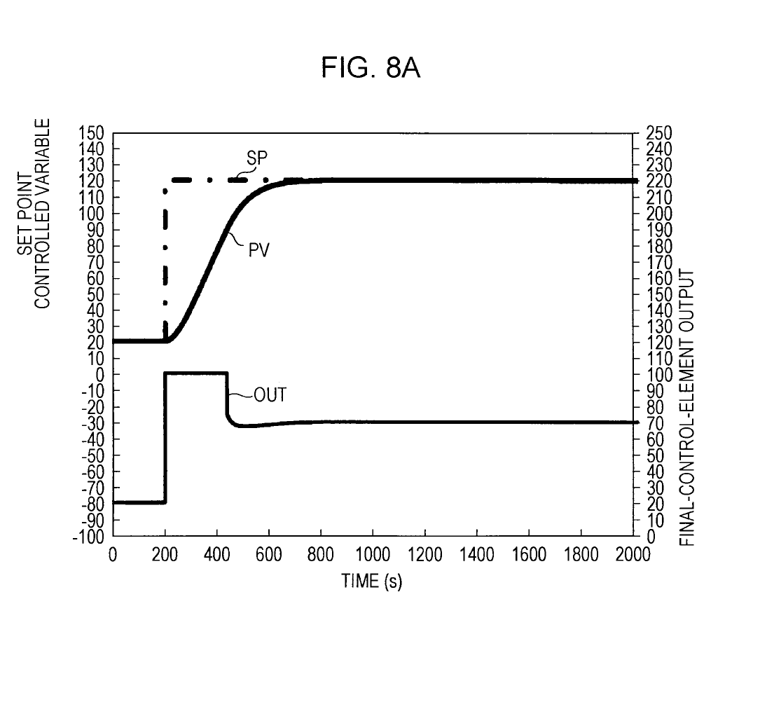

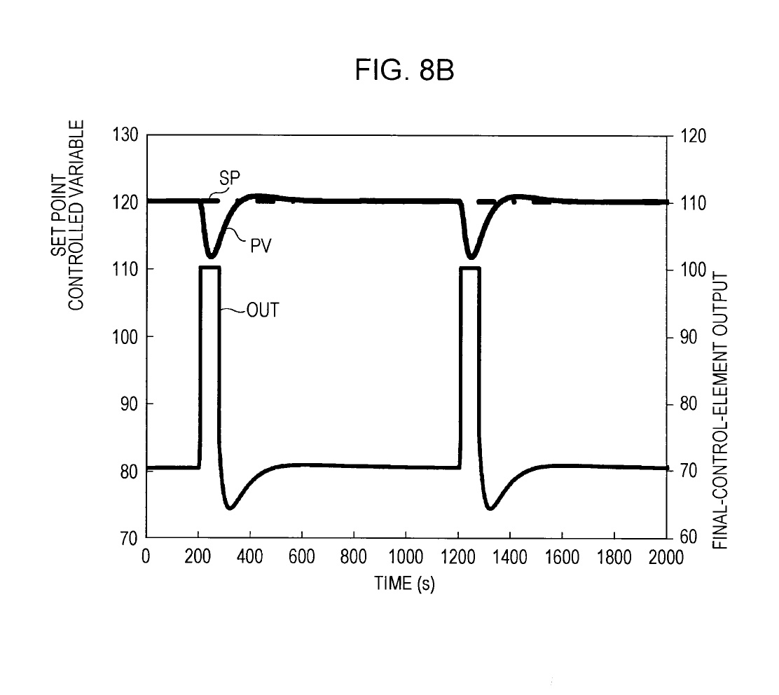

FIG. 7A is a diagram illustrating an example of a control response when a set point is changed in a case where the first embodiment is applied to a controller having an anti-integral windup function. FIG. 7B is a diagram illustrating an example of a control response when a disturbance is applied in the case where the first embodiment is applied to a controller having an anti-integral windup function. FIG. 8A is a diagram illustrating an example of a control response when a set point is changed in the second embodiment. FIG. 8B is a diagram illustrating an example of a control response when a disturbance is applied in the second embodiment.

In the examples in FIGS. 7A and 7B, the upper limit ARWH is equal to the final-control-element output upper limit H, H being equal to 100 (ARWH=H=100), and the lower limit ARWL is equal to the final-control-element output lower limit L, L being equal to 0 (ARWL=L=0). In contrast, the upper limit ARWH is equal to 170 (ARWH=170) and the lower limit ARWL is equal to 0 (ARWL=0) in the example in FIG. 8A. The upper limit ARWH is equal to 110 (ARWH=110) and the lower limit ARWL is equal to the final-control-element output lower limit L, L being equal to 0 (ARWL=L=0) in the example in FIG. 8B. As a result, integral windup is prevented with the upper limit ARWH, and therefore, a period over which the control computation output value MV is equal to or larger than the threshold A can be extended, and the controlled variable can reach the set point earlier. As described above, in this embodiment, the configuration according to the first embodiment is employed while the final-control-element output upper and lower limits (H and L) are separated from the upper and lower limits for anti-integral windup (ARWH and ARWL), and the values of ARWH and ARWL are adjusted so as to produce a control response most desired by the user, thereby achieving good control responsivity.

In the first and second embodiments, the example is described in which control is performed to increase the controlled variable PV in a control system in which the controlled variable PV increases in response to an increase in the final-control-element output OUT. In contrast, in a case of performing control to decrease the controlled variable PV in a control system in which the controlled variable PV decreases in response to an increase in the final-control-element output OUT (for example, in a case where the set point SP is changed so as to become higher or in a case where a disturbance that decreases the controlled variable PV is applied), the control computation output value MV calculated by the control computation unit 1 or 1a increases, and the final-control-element output OUT increases accordingly, resulting in a decrease in the controlled variable PV. Therefore, the first and second embodiments can be applied as they are also in this case.

In a case of performing control to decrease the controlled variable PV in the control system in which the controlled variable PV increases in response to an increase in the final-control-element output OUT (for example, in a case where the set point SP is changed so as to become lower or in a case where a disturbance that increases the controlled variable PV is applied), or in a case of performing control to increase the controlled variable PV in the control system in which the controlled variable PV decreases in response to an increase in the final-control-element output OUT (for example, in the case where the set point SP is changed so as to become higher or in the case where a disturbance that decreases the controlled variable PV is applied), the control computation output value MV calculated by the control computation unit 1 or 1a decreases, and the final-control-element output OUT decreases accordingly. Therefore, the final-control-element output lower limit L is used instead of the final-control-element output upper limit H.

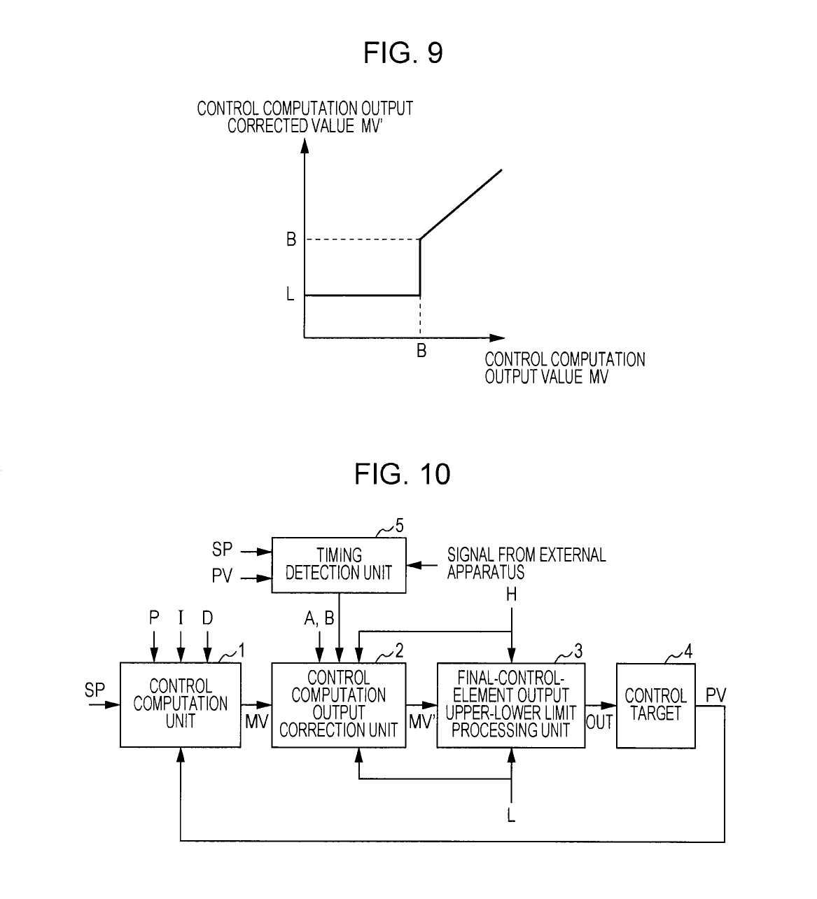

Here, when the control computation output value MV calculated by the control computation unit 1 or 1a becomes equal to or lower than a threshold B specified by the user, the control computation output value MV is corrected to the final-control-element output lower limit L. That is, in a case where the control computation output value MV is larger than the threshold B as illustrated in FIG. 9, the control computation output correction unit 2 outputs the control computation output value MV as the control computation output corrected value MV′ without correction (MV′=MV). In a case where the control computation output value MV is equal to or smaller than the threshold B, the control computation output correction unit 2 outputs the final-control-element output lower limit L as the control computation output corrected value MV′ (MV′=L). The user may specify the value of the threshold B that satisfies the following condition,

MV₊>B>L (4).

In expression (4), MV₊ represents the smaller one of the control computation output value MV calculated during a control settling period after a set point change and the control computation output value MV calculated during a control settling period after application of a disturbance. The user may change the threshold B so that the threshold B gradually approaches the control computation output value MV₊ from the final-control-element output lower limit L by operating the threshold input unit (not illustrated) of the controller, and end the adjustment when a control response most desired by the user is produced.

Consequently, in the case of performing control to decrease the controlled variable PV in the control system in which the controlled variable PV increases in response to an increase in the final-control-element output OUT, or in the case of performing control to increase the controlled variable PV in the control system in which the controlled variable PV decreases in response to an increase in the final-control-element output OUT, the effects described in the first and second embodiments can be achieved.

### Third Embodiment

The first and second embodiments assume that the same values are used as the threshold A that is used in a case of a set point change and as the threshold A that is used in a case of application of a disturbance and that the same values are used as the threshold B that is used in a case of a set point change and as the threshold B that is used in a case of application of a disturbance. However, if further improvement of a control response upon a set point change and further improvement of a control response upon application of a disturbance are desired individually, different values need to be respectively used as the threshold A that is used in a case of a set point change and as the threshold A that is used in a case of application of a disturbance, and different values need to be respectively used as the threshold B that is used in a case of a set point change and as the threshold B that is used in a case of application of a disturbance. In this embodiment, a case of switching between thresholds as described above is described.

FIG. 10 is a block diagram illustrating a configuration of a controller according to the third embodiment of the present invention. The same constituent element as that in FIG. 4 or 6 is assigned the same reference numeral. The controller illustrated in FIG. 10 is a controller constituted by the controller according to the first embodiment and a timing detection unit 5.

The timing detection unit 5 detects a timing at which the thresholds A and B are to be switched to the thresholds A and B that are used in a case of a set point change and a timing at which the thresholds A and B are to be switched to the thresholds A and B that are used in a case of application of a disturbance. As the timings at which switching is to be performed, trigger timings of events, alarms, and so on detected by general industrial measuring instruments are used. Examples of the timings at which switching is to be performed include:

(a) a timing at which the set point SP is changed;

(b) a timing at which a signal for communicating a change of the set point SP is received from an external apparatus;

(c) a timing at which the time elapsed since a change of the set point SP reaches a specified time;

(d) a timing at which, although the set point SP is not changed, the deviation (SP-PV) reaches or exceeds a predetermined deviation upper limit;

(e) a timing at which, although the set point SP is not changed, the deviation (SP-PV) reaches or falls below a predetermined deviation lower limit; and

(f) a timing at which a signal for communicating application of a disturbance is received from an external apparatus.

When at least one of the events described in (a) to (c) occurs, the timing detection unit 5 determines the timing of the event to be a timing at which the thresholds A and B are to be switched to the thresholds A and B that are used in a case of a set point change. When at least one of the events described in (d) to (f) occurs, the timing detection unit 5 determines the timing of the event to be a timing at which the thresholds A and B are to be switched to the thresholds A and B that are used in a case of application of a disturbance.

For example, in a chemical manufacturing apparatus, there is a case where the temperature (controlled variable PV) of the furnace for chemical manufacturing is repeatedly changed. In this case, how the set point SP (the set point of the temperature) is changed is known in advance, and therefore, the external apparatus is able to transmit a signal for communicating a change of the set point SP to the controller of this embodiment at a timing when the set point SP is changed.

In a reflow oven in which the set point SP (the set point of the temperature) is constant, there is a case where the temperature changes in response to a printed circuit board that is subjected to a soldering operation being periodically thrown into the reflow oven. In this case, a controller (an external apparatus) that controls conveyance of printed circuit boards is able to transmit a signal for communicating application of a disturbance to the controller of this embodiment at a timing when a printed circuit board is thrown into the reflow oven.

Determination of the timings is not limited to the above examples. For example, when at least one of the events described in (a) and (b) occurs, the timing detection unit 5 may determine the timing of the event to be a timing at which the thresholds A and B are to be switched to the thresholds A and B that are used in a case of a set point change, and when at least one of the events described in (c) to (f) occurs, the timing detection unit 5 may determine the timing of the event to be a timing at which the thresholds A and B are to be switched to the thresholds A and B that are used in a case of application of a disturbance.

In the control computation output correction unit 2, the threshold A that is used in a case of a set point change, the threshold A that is used in a case of application of a disturbance, the threshold B that is used in a case of a set point change, and the threshold B that is used in a case of application of a disturbance are separately set. The threshold A that is used in a case of a set point change has a value that is larger than the control computation output value MV calculated during a control settling period after a set point change and is smaller than the final-control-element output upper limit H. The threshold A that is used in a case of application of a disturbance has a value that is larger than the control computation output value MV calculated during a control settling period after application of a disturbance and is smaller than the final-control-element output upper limit H. The threshold B that is used in a case of a set point change has a value that is larger than the final-control-element output lower limit L and is smaller than the control computation output value MV calculated during a control settling period after a set point change. The threshold B that is used in a case of application of a disturbance has a value that is larger than the final-control-element output lower limit L and is smaller than the control computation output value MV calculated during a control settling period after application of a disturbance.

In a case where the timing detection unit 5 determines the detected timing to be a timing at which switching to the thresholds A and B that are used in a case of a set point change is to be performed, the control computation output correction unit 2 switches the thresholds A and B to be used to the thresholds A and B that are used in a case of a set point change. In a case where the timing detection unit 5 determines the detected timing to be a timing at which switching to the thresholds A and B that are used in a case of application of a disturbance is to be performed, the control computation output correction unit 2 switches the thresholds A and B to be used to the thresholds A and B that are used in a case of application of a disturbance. Operations other than the timing-related operation are the same as those described in the first and second embodiments.

As evident from the descriptions given above, the control computation output correction unit 2 may make a correction by using only the threshold A, may make a correction by using only the threshold B, or may make a correction by using both the thresholds A and B. FIG. 10 illustrates the case where switching between the thresholds is applied to the first embodiment; however, the switching between the thresholds is easily applicable to the second embodiment as a matter of course.

The controllers according to the first to third embodiments are each implemented by using a computer that includes a central processing unit (CPU), a storage device, and an interface, and a program for controlling these hardware resources. The CPU performs the processes described in the first to third embodiments in accordance with the program stored in the storage device.

Embodiments of the present invention are applicable to various types of control, such as temperature control.

What is claimed is:

1. A controller comprising:
a control computation unit that calculates, for each control cycle, a control computation output value by performing a control computation using a controlled variable and a set point as input values;
a control computation output correction unit that corrects the control computation output value calculated by the control computation unit to a predetermined final-control-element output upper limit in a case where the control computation output value is equal to or larger than a predetermined threshold A; and
a final-control-element output upper-lower limit processing unit that outputs to a control target a value obtained by limiting the control computation output value corrected by the control computation output correction unit to a value that is equal to or larger than a predetermined final-control-element output lower limit and that is equal to or smaller than the final-control-element output upper limit, as a final-control-element output value.

2. A controller comprising:
a control computation unit that calculates, for each control cycle, a control computation output value by performing a control computation using a controlled variable and a set point as input values;
a control computation output correction unit that corrects the control computation output value calculated by the control computation unit to a predetermined final-control-element output lower limit in a case where the control computation output value is equal to or smaller than a predetermined threshold B; and
a final-control-element output upper-lower limit processing unit that outputs to a control target a value obtained by limiting the control computation output value corrected by the control computation output correction unit to a value that is equal to or larger than the final-control-element output lower limit and that is equal to or smaller than a predetermined final-control-element output upper limit, as a final-control-element output value.

3. The controller according to claim 1, wherein
the threshold A is larger than a lager one of the control computation output value that is calculated by the control computation unit during a control settling period after a set point change and the control computation output value that is calculated by the control computation unit during a control settling period after application of a disturbance, and is smaller than the final-control-element output upper limit.

4. The controller according to claim 1, further comprising:
a timing detection unit that, in response to an event that corresponds to a set point change or to application of a disturbance, detects a timing at which the threshold A is to be switched to the threshold A that is used in a case of a set point change or a timing at which the threshold A is to be switched to the threshold A that is used in a case of application of a disturbance, wherein
the threshold A is set to a value that is used in a case of a set point change and to a value that is used in a case of application of a disturbance,
the control computation output correction unit switches, in a case where the timing detection unit determines the detected timing to be the timing at which the threshold A is to be switched to the threshold A that is used in a case of a set point change, the threshold A to be used to the threshold A that is used in a case of a set point change, and switches, in a case where the timing detection unit determines the detected timing to be the timing at which the threshold A is to be switched to the threshold A that is used in a case of application of a disturbance, the threshold A to be used to the threshold A that is used in a case of application of a disturbance,
the threshold A that is used in a case of a set point change is larger than the control computation output value calculated by the control computation unit during a control settling period after a set point change and is smaller than the final-control-element output upper limit, and
the threshold A that is used in a case of application of a disturbance is larger than the control computation output value calculated by the control computation unit during a control settling period after application of a disturbance and is smaller than the final-control-element output upper limit.

5. The controller according to claim 2, wherein
the threshold B is larger than the final-control-element output lower limit, and is smaller than a smaller one of the control computation output value that is calculated by the control computation unit during a control settling period after a set point change and the control computation output value that is calculated by the control computation unit during a control settling period after application of a disturbance.

6. The controller according to claim 2, further comprising:
a timing detection unit that, in response to an event that corresponds to a set point change or to application of a disturbance, detects a timing at which the threshold B is to be switched to the threshold B that is used in a case of a set point change or a timing at which the threshold B is to be switched to the threshold B that is used in a case of application of a disturbance, wherein
the threshold B is set to a value that is used in a case of a set point change and to a value that is used in a case of application of a disturbance,
the control computation output correction unit switches, in a case where the timing detection unit determines the detected timing to be the timing at which the threshold B is to be switched to the threshold B that is used in a case of a set point change, the threshold B to be used to the threshold B that is used in a case of a set point change, and switches, in a case where the timing detection unit determines the detected timing to be the timing at which the threshold B is to be switched to the threshold B that is used in a case of application of a disturbance, the threshold B to be used to the threshold B that is used in a case of application of a disturbance,
the threshold B that is used in a case of a set point change is larger than the final-control-element output lower limit and is smaller than the control computation output value calculated by the control computation unit during a control settling period after a set point change, and
the threshold B that is used in a case of application of a disturbance is larger than the final-control-element output lower limit and is smaller than the control computation output value calculated by the control computation unit during a control settling period after application of a disturbance.

7. A control method comprising:
a control computation step of calculating, for each control cycle, a control computation output value by performing a control computation using a controlled variable and a set point as input values;
a control computation output correction step of correcting the control computation output value calculated in the control computation step to a predetermined final-control-element output upper limit in a case where the control computation output value is equal to or larger than a predetermined threshold A; and
a final-control-element output upper-lower limit processing step of outputting to a control target a value obtained by limiting the control computation output value corrected in the control computation output correction step to a value that is equal to or larger than a predetermined final-control-element output lower limit and that is equal to or smaller than the final-control-element output upper limit, as a final-control-element output value.

8. A control method comprising:
a control computation step of calculating, for each control cycle, a control computation output value by performing a control computation using a controlled variable and a set point as input values;
a control computation output correction step of correcting the control computation output value calculated in the control computation step to a predetermined final-control-element output lower limit in a case where the control computation output value is equal to or smaller than a predetermined threshold B; and
a final-control-element output upper-lower limit processing step of outputting to a control target a value obtained by limiting the control computation output value corrected in the control computation output correction step to a value that is equal to or larger than the final-control-element output lower limit and that is equal to or smaller than a predetermined final-control-element output upper limit, as a final-control-element output value.

9. The control method according to claim 7, wherein
the threshold A is larger than a lager one of the control computation output value that is calculated in the control computation step during a control settling period after a set point change and the control computation output value that is calculated in the control computation step during a control settling period after application of a disturbance, and is smaller than the final-control-element output upper limit.

10. The control method according to claim 7, further comprising:
a timing detection step of, in response to an event that corresponds to a set point change or to application of a disturbance, detecting a timing at which the threshold A is to be switched to the threshold A that is used in a case of a set point change or a timing at which the threshold A is to be switched to the threshold A that is used in a case of application of a disturbance, wherein
the threshold A is set to a value that is used in a case of a set point change and to a value that is used in a case of application of a disturbance,
the control computation output correction step further includes a step of switching, in a case where the detected timing is determined to be the timing at which the threshold A is to be switched to the threshold A that is used in a case of a set point change in the timing detection step, the threshold A to be used to the threshold A that is used in a case of a set point change, and switching, in a case where the detected timing is determined to be the timing at which the threshold A is to be switched to the threshold A that is used in a case of application of a disturbance in the timing detection step, the threshold A to be used to the threshold A that is used in a case of application of a disturbance,
the threshold A that is used in a case of a set point change is larger than the control computation output value calculated in the control computation step during a control settling period after a set point change and is smaller than the final-control-element output upper limit, and
the threshold A that is used in a case of application of a disturbance is larger than the control computation output value calculated in the control computation step during a control settling period after application of a disturbance and is smaller than the final-control-element output upper limit.

11. The control method according to claim 8, wherein
the threshold B is larger than the final-control-element output lower limit, and is smaller than a smaller one of the control computation output value that is calculated in the control computation step during a control settling period after a set point change and the control computation output value that is calculated in the control computation step during a control settling period after application of a disturbance.

12. The control method according to claim 8, further comprising:
a timing detection step of, in response to an event that corresponds to a set point change or to application of a disturbance, detecting a timing at which the threshold B is to be switched to the threshold B that is used in a case of a set point change or a timing at which the threshold B is to be switched to the threshold B that is used in a case of application of a disturbance, wherein
the threshold B is set to a value that is used in a case of a set point change and to a value that is used in a case of application of a disturbance,
the control computation output correction step further includes a step of switching, in a case where the detected timing is determined to be the timing at which the threshold B is to be switched to the threshold B that is used in a case of a set point change in the timing detection step, the threshold B to be used to the threshold B that is used in a case of a set point change, and switching, in a case where the detected timing is determined to be the timing at which the threshold B is to be switched to the threshold B that is used in a case of application of a disturbance in the timing detection step, the threshold B to be used to the threshold B that is used in a case of application of a disturbance,
the threshold B that is used in a case of a set point change is larger than the final-control-element output lower limit and is smaller than the control computation output value calculated in the control computation step during a control settling period after a set point change, and
the threshold B that is used in a case of application of a disturbance is larger than the final-control-element output lower limit and is smaller than the control computation output value calculated in the control computation step during a control settling period after application of a disturbance.
